(19) United States
(12) Patent Application Publication
(10) Pub. No.: US 2011/0200927 A1
(43) Pub. Date: Aug. 18, 2011

(54) ELECTROPHOTOGRAPHIC TONER

(75) Inventors: Moon-il JUNG, Suwon-si (KR); In-sik PARK, Suwon-si (KR); Hyung CHOI, Seongnam-si (KR); Seung-jin OH, Seoul (KR)

(73) Assignee: Samsung Electronics Co., Ltd, Suwon-si (KR)

(21) Appl. No.: 12/909,956

(22) Filed: Oct. 22, 2010

(30) Foreign Application Priority Data
Feb. 17, 2010 (KR) 2010-0014243

(51) Int. Cl. G03G 9/00; G03G 15/08

(52) U.S. Cl. 430/105; 399/258

(57) ABSTRACT

An electrophotographic toner, a method of preparing the electrophotographic toner, and an image forming apparatus using the electrophotographic toner. The electrophotographic toner includes a binder resin, a colorant, a releasing agent, and a spherical metal nanoparticle having a volume average diameter of about 10 to about 100 nm.

### CROSS-REFERENCE TO RELATED APPLICATIONS

This application claims priority under 35 U.S.C. §119(a) from Korean Patent Application No. 10-2010-0014243, filed on Feb. 17, 2010, in the Korean Intellectual Property Office, the disclosure of which is incorporated herein in its entirety by reference.

### BACKGROUND

1. Field of the Invention

The present general inventive concept relates to an electrophotographic toner, a method of preparing the electrophotographic toner, and an image forming apparatus using the electrophotographic toner.

2. Description of the Related Art

Developers that are used to visualize electrostatic images or electrostatic latent images in electrographic or electrostatic processes can be classified into two-component developers and one-component developers. Two-component developers include toner and carrier particles whereas one-component developers consist exclusively of toner. One-component developers can be further classified into magnetic and nonmagnetic developers. In order to increase the fluidity of toner, nonmagnetic one-component developers often contain a fluidizing agent, such as colloidal silica. Typically, toner includes coloring particles obtained by dispersing a colorant, such as carbon black, or other additives, in latex.

Methods for preparing toner include pulverization and polymerization processes. In the pulverization process, toner is obtained by melting and mixing a synthetic resin with a colorant, and optionally, other additives. After pulverizing, this mixture undergoes sorting until particles of a desired size are obtained. In contrast, toner is obtained in the polymerization process by uniformly dissolving or dispersing various additives, such as a colorant, a polymerization initiator, and optionally, a cross-linking agent and an antistatic agent, in a polymerizable monomer. The polymerizable monomer composition is then dispersed in an aqueous dispersive medium, which includes a dispersion stabilizer, using an agitator to shape minute liquid droplet particles. The temperature of the composition is subsequently increased, and suspension polymerization is performed to obtain a polymerized toner having coloring polymer particles of a desired size.

Typically, toner used in an imaging apparatus is obtained by pulverization. However, in pulverization it is difficult to precisely control a particle size, geometric size distribution, and toner structure, and thus, it is difficult to separately design the major characteristics of toner, such as charging characteristics, fixability, flowability, and preservation characteristics.

Recently, the use of polymerized toner has increased due to the simpler manufacturing process, which does not require sorting the particles, and due also to the ease of controlling the size of the particles. When toner is prepared through a polymerization process, polymerized toner having a desired particle size and particle size distribution can be obtained without pulverizing or sorting.

A printer fuser fuses toner onto a sheet by applying pressure and heat to the toner according to an electrostatic force. A time taken to heat the toner is related directly to a warming up time as a parameter for fusing toner, and power consumption. Thus, along with an increased interest in environmental issues, interest in the durability of system members and environmentally compatible energy has also increased, and thus interest in low temperature fixation has increased. To this end, systematic and material attempts have been tried. In particular, from a material point of view, a method of reducing a softening temperature of toner is more complex and difficult than a method of changing a temperature of a fixing system, and thus the development of the method of reducing a softening temperature of toner has not been simply attempted.

### SUMMARY

According to exemplary embodiments of the present general inventive concept, there is provided an electrophotographic toner including a binder resin, a colorant, a releasing agent, and a spherical metal nanoparticle having a volume average diameter of about 10 to about 100 nm.

Additional features and utilities of the present general inventive concept will be set forth in part in the description which follows and, in part, will be obvious from the description, or may be learned by practice of the present general inventive concept.

The binder resin may be at least one selected from the group consisting of a styrene resin, an acryl resin, a vinyl resin, a polyether polyol resin, a phenol resin, a silicon resin, a polyester resin, an epoxy resin, a polyamide resin, a polyurethane resin, and a polybutadiene resin.

A molecular weight of binder resin may be in a range of about 700 to about 3,000.

The spherical metal nanoparticle may be at least one selected from the group consisting of silver (Ag), gold (Au), platinum (Pt), palladium (Pd), iron (Fe), nickel (Ni), aluminum (Al), antimony (Sb), tungsten (W), terbium (Tb), dysprosium (Dy), gadolinium (Gd), europium (Eu), neodymium (Nd), praseodymium (Pr), strontium (Sr), magnesium (Mg), copper (Cu), zinc (Zn), cobalt (Co), manganese (Mn), chromium (Cr), vanadium (V), molybdenum (Mo), zirconium (Zr), and barium (Ba).

An amount of the colorant can be in a range of about 0.1 to about 20 parts by weight, an amount of the releasing agent can be in a range of about 1 to about 20 parts by weight, and an amount of the spherical metal nanoparticle can be in a range of about 0.005 to about 10 parts by weight, based on 100 parts by weight of the binder resin.

A surface of the spherical metal nanoparticle may be surrounded by a surfactant or a dispersant.

The surfactant may be at least one selected from the group consisting of salts of sulfate ester-based surfactant, salts of sulfonate-based surfactant, salts of phosphate ester-based surfactant, soap-based surfactant, an amine-salt surfactant, a quaternary ammonium salt surfactant, a polyethylene glycol-based surfactant, an alkylphenolethyleneoxide adduct-based surfactant, a polyvalent alcohol-based surfactant, and a nitrogen-containing vinyl polymer-based surfactant.

Exemplary embodiments of the present general inventive concept provide a method of preparing an electrophotographic toner, the method including preparing a mixture solution including a polymerizable monomer, a colorant, a releasing agent, and a spherical metal nanoparticle, combining the mixture solution with an aqueous dispersion solution prepared by dissolving a dispersant in water so that suspension polymerization proceeds, and removing the dispersant and drying the resultant to form toner particles.

An amount of the colorant may be in a range of about 0.1 to about 20 parts by weight, an amount of the releasing agent is in a range of about 1 to about 20 parts by weight, and an amount of the spherical metal nanoparticle may be in a range of about 0.005 to about 10 parts by weight, based on 100 parts by weight of the polymerizable monomer.

The spherical metal nanoparticle may be at least one selected from the group consisting of silver (Ag), gold (Au), platinum (Pt), palladium (Pd), iron (Fe), nickel (Ni), aluminum (Al), antimony (Sb), tungsten (W), terbium (Tb), dysprosium (Dy), gadolinium (Gd), europium (Eu), neodymium (Nd), praseodymium (Pr), strontium (Sr), magnesium (Mg), copper (Cu), zinc (Zn), cobalt (Co), manganese (Mn), chromium (Cr), vanadium (V), molybdenum (Mo), zirconium (Zr), and barium (Ba).

The mixture solution may include the spherical metal nanoparticle that is dispersed in a surfactant or a dispersant.

The surfactant may be at least one selected from the group consisting of salts of sulfate ester-based surfactant, salts of sulfonate-based surfactant, salts of phosphate ester-based surfactant, soap-based surfactant, an amine-salt surfactant, a quaternary ammonium salt surfactant, a polyethylene glycol-based surfactant, an alkylphenolethyleneoxide adduct-based surfactant, a polyvalent alcohol-based surfactant, and a nitrogen-containing vinyl polymer-based surfactant.

Exemplary embodiments of the present general inventive concept can also provide a toner supplying device including a toner, and a housing for accommodating the toner, where the toner is an electrophotographic toner including a binder resin, a colorant, a releasing agent, and a spherical metal nanoparticle having a volume average diameter of about 10 to about 100 nm.

Exemplary embodiments of the present general inventive concept can also provide an image forming apparatus including an image carrier, an image forming unit to form an electrostatic latent image on a surface of the image carrier, a unit receiving toner, a toner-supplying unit for supplying the toner to the surface of the image carrier in order to develop the electrostatic latent image into a toner image on the surface of the image carrier, and a toner transferring unit for transferring the toner image onto the surface of the image carrier, where the toner may be an electrophotographic toner including a binder resin, a colorant, a releasing agent, and a spherical metal nanoparticle having a volume average diameter of about 10 to about 100 nm.

Exemplary embodiments of the present general inventive concept can also provide an electrophotographic toner in which a fusing temperature for fusing a toner is reduced to reduce power consumption, thereby reducing a first paper out time (FPOT).

Exemplary embodiments of the present general inventive concept may also provide a method of preparing an electrophotographic toner, the method including forming a binder region dispersion solution by emulsion aggregation and forming a colorant dispersion solution by dispersing a colorant in a solvent, where the binder region dispersion solution and the colorant dispersion solution are mixed with each other to form agglomerates having a predetermined diameter, heating and fused-coalescing the formed agglomerates, and mixing a spherical metal nanoparticle with the binder resin dispersion solution or the colorant dispersion solution.

### BRIEF DESCRIPTION OF THE DRAWINGS

The above and/or other features and utilities of the present general inventive concept will become apparent and more readily appreciated from the following description of the exemplary embodiments, taken in conjunction with the accompanying drawings, in which:

FIG. 1 is a view illustrating a toner supplying device according to exemplary embodiments of the present general inventive concept;

FIG. 2 is a cross-sectional view illustrating an image forming apparatus of a non-contact type one component developing method, according to exemplary embodiments of the present general inventive concept;

FIG. 3 is a schematic diagram illustrating an image forming apparatus using a toner, according to exemplary embodiments of the present general inventive concept;

FIG. 4 is a schematic diagram illustrating an image forming apparatus using a toner, according to exemplary embodiments of the present general inventive concept;

FIG. 5 is a graph illustrating viscosities of electrophotographic toners prepared in Example 1 and Comparative Example 1 according to a temperature; and

FIGS. 6 through 8 are graphs illustrating fixabilities of electrophotographic toners prepared in Example 1 and Comparative Example 1 at temperatures of 160° C., 170° C., and 180° C., respectively, according to exemplary embodiments of the present general inventive concept.

### DETAILED DESCRIPTION OF THE EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

An electrophotographic toner according to exemplary embodiments of the present general inventive concept can include a binder resin, a colorant, a releasing agent, and a spherical metal nanoparticle having a volume average diameter of about 10 nm to about 100 nm.

The binder resin may be a styrene resin, an acryl resin, a vinyl resin, a polyether polyol resin, a phenol resin, a silicon resin, a polyester resin, an epoxy resin, a polyamide resin, a polyurethane resin, a polybutadiene resin, or the like, but is not limited thereto. The resins may be used alone or in a combination.

The styrene resin may be: polystyrene; a homopolymer of styrene substituent such as poly-p-chlorostyrene, or polyvinyltoluene; or a styrene-based copolymer such as a styrene-p-chlorostyrene copolymer, a styrene-vinyltoluene copolymer, a styrene-vinylnaphthalene copolymer, a styrene-acrylic acid ester copolymer, a styrene-methacrylic acid ester copolymer, a styrene-α-chloromethacrylic acid methyl copolymer, a styrene-acrylonitrile copolymer, a styrene-vinylmethylether copolymer, a styrene-vinylethylether copolymer, a styrene-vinyl methyl ketone copolymer, a styrene-butadiene copolymer, a styrene-isoprene copolymer, or a styrene-acrylonitrile-indene copolymer. Examples of the acryl resin may include an acrylic acid polymer, a methacrylic acid polymer, a methyl methacrylateester polymer, and a a-chloromethacrylic acid methylester polymer. Examples of the vinyl resin may include a vinyl chloride polymer, an ethylene polymer, a propylene polymer, an acrylonitrile polymer, and a vinyl acetate polymer.

A number average molecular weight of the binder resin can be, for example, from about 700 to about 3,000, or from about 1,000 to about 2,000. When the number average molecular weight of the binder resin is from about 700 to about 3,000, the viscosity of a toner may be reduced, and thus a fusing temperature for fusing the toner may be reduced.

In the case of a toner to form black and white images, the toner may include carbon black or aniline black as the colorant. In the case of a color toner, the color toner may use carbon black as a black colorant, and may include yellow, magenta and cyan colorants as color pigments.

The yellow colorant may be a condensed nitrogen compound, an isoindolinone compound, an anthraquinone compound, an azo metal complex, or an allyl imide compound. Examples of the yellow colorant include, but are not limited to, C.I. (color index) pigment yellows 12, 13, 14, 17, 62, 74, 83, 93, 94, 95, 109, 110, 111, 128, 129, 147, 168, and 180.

Examples of the magenta colorant include, but are not limited to, condensed nitrogen compounds, anthraquine compounds, quinacridone compounds, base dye lake compounds, naphthol compounds, benzo imidazole compounds, thioindigo compounds, and perylene compounds. Examples of the magenta colorant can include, but are not limited to, C.I. pigment reds 2, 3, 5, 6, 7, 23, 48:2, 48:3, 48:4, 57:1, 81:1, 122, 144, 146, 166, 169, 177, 184, 185, 202, 206, 220, 221, and 254.

Examples of the cyan colorant can include, but are not limited to, copper phthalocyanine compounds and derivatives thereof, anthraquinone compounds, and base dye lake compounds. Examples of the cyan colorant can include, but are not limited to, C.I. pigment blues 1, 7, 15, 15:1, 15:2, 15:3, 15:4, 60, 62, and 66.

These colorants may be used alone or in combination of at least two thereof, and may be selected in consideration of color, chromaticity, brightness, weather resistance (e.g., resistance to environmental exposure), or dispersibility in toner.

The colorant may be of any amount so as to color the toner. For example, the amount of the colorant may be from about 0.1 to about 20, or from about 2 to about 10 parts by weight based on 100 parts by weight of the binder resin. When the amount of the colorant is from about 0.1 to about 20 parts by weight based on 100 parts by weight of the binder resin, the coloring effect of the colorant may be sufficiently obtained, the manufacturing costs of the toner may not be increased, and a sufficient quantity of friction electric charge may be obtained.

Suitable releasing agents may be selected according to desired properties of a target toner. Examples of suitable releasing agents include, but are not limited to, polyethylene-based wax, polypropylene-based wax, silicon wax, paraffin-based wax, ester-based wax, carnauba wax, and metallocene wax.

The releasing agent may be wax having a melting point of about 50° C. to about 150° C. so as to increase the releasing properties of the releasing agent. As the melting point of the releasing agent is further increased, the dispersibility of toner particles may deteriorate and/or decrease. As the melting point of the releasing agent is reduced and/or decreased, even though the dispersibility of the toner particles may be improved, the melting point of the releasing agent may be in the range of about 50° C. to about 150° C., depending on environmental factors inside an electrophotographic device that uses toner, and the fixability of a final printed image. The releasing agent may be physically attached to the toner particles, but may not be bonded (e.g., covalently bonded) with them. The releasing agent can fix the toner to a final image receptor at a decreased (e.g., low) fixing temperature and have increased final image durability and abrasion-resistance characteristics.

The amount of the releasing agent may be, for example, from about 1 to about 20, or from about 1 to about 10 parts by weight based on 100 parts by weight of the binder resin. When the amount of the releasing agent is from about 1 to about 20 parts by weight based on 100 parts by weight of the binder resin, the releasing properties and durability of a prepared toner may be improved and/or increased.

The spherical metal nanoparticle may be at least one selected from the group consisting of silver (Ag), gold (Au), platinum (Pt), palladium (Pd), iron (Fe), nickel (Ni), aluminum (Al), antimony (Sb), tungsten (W), terbium (Tb), dysprosium (Dy), gadolinium (Gd), europium (Eu), neodymium (Nd), praseodymium (Pr), strontium (Sr), magnesium (Mg), copper (Cu), zinc (Zn), cobalt (Co), manganese (Mn), chromium (Cr), vanadium (V), molybdenum (Mo), zirconium (Zr), and barium (Ba).

The spherical metal nanoparticle may have a volume average diameter of, for example, about 10 to about 100 nm, about 15 to about 70 nm, or about 20 to about 50 nm. When the volume average diameter of the spherical metal nanoparticle is in the range of about 10 to about 100 nm, the spherical metal nanoparticle may be equally or about equally dispersed in the toner, a thermal conduction may be obtained when heat is applied from an external heat source to fix the toner, and the spherical metal nanoparticle may be handled during the preparation of the toner.

The amount of the spherical metal nanoparticle can be, for example, from about 0.005 to about 10, or from about 0.01 to about 5 parts by weight based on 100 parts by weight of the binder resin. When the amount of the spherical metal nanoparticle is in the range of about 0.005 to about 10 parts by weight based on 100 parts by weight of the binder resin, the spherical metal nanoparticle may be equally dispersed, rather than being aggregated in the toner. When heat is applied from an external heat source to fix the toner, since heat is dispersed throughout the toner due to the thermal conductivity of the spherical metal nanoparticle, the same fixability may be obtained at a lower fusing temperature than a fusing temperature to fuse a typical toner.

The spherical metal nanoparticle may be added as a dispersion solution including a surfactant or a dispersant to stably maintain a dispersion state during the preparation of the toner. A surface of the spherical metal nanoparticle may be surrounded by the surfactant or the dispersant.

Examples of the surfactant may include an anionic surfactant such as: salts of sulfate ester-based anionic surfactant, salts of sulfonate-based anionic surfactant, salts of phosphate ester-based anionic surfactant, and a soap-based anionic surfactant; a cationic surfactant such as an amine-salt cationic surfactant, and a quaternary ammonium salt cationic surfactant; and a nonionic surfactant such as a polyethylene glycol-based nonionic surfactant, an alkylphenolethyleneoxide adduct-based nonionic surfactant, and a polyvalent alcohol-based nonionic surfactant.

The nonionic surfactant may be used together with the anionic surfactant or the cationic surfactant. These surfactants may be used alone or in a combination of at least two thereof.

Examples of the anionic surfactant may include: stearate fatty acid such as lauric acid potassium, oleic acid sodium, and castor oil sodium; sulfuric ester such as octylsulfate, lauryl sulfate, lauryl ethersulfate, and nonylphenylether sulfate; alkyl naphthalene sulfonic acid sodium such as lauryl sulfonate, dodecyl sulfonate, dodecyl benzene sulfonate, triisopropyl naphthalene sulfonate, and dibutyl naphthalene sulfonate; sulfonate such as naphthalene sulfonate formalin condensate, monooctyl sulfosuccinate, dioctyl sulfosuccinate, lauric acid amide sulfonate, and oleic acid amide sulfonate; phosphoric acid ester such as lauryl phosphate, isopropylphosphate, and nonylphenylether phosphate; dialkylsulfosuccinic acid sodium such as dioctylsulfosuccinic acid sodium; and sulfosuccinate such as sulfosuccinic acid lauryl 2 sodium, and polyoxyethylenesulfosuccinic acid lauryl 2 sodium.

Examples of the cationic surfactant may include: amine salt such as lauryl amine hydrochloride, stearylamine hydrochloride, oleylamine aceate, stearylamine acetic acetate, and stearylaminopropylamine acetate; and quaternary ammonium salt such as lauryl trimethylammonium chloride, dilauryl dimethylammonium chloride, distearylammonium chloride, distearyldimethylammonium chloride, lauryl dihydroxyethylmethylammonium chloride, oleylbispolyoxyethylenemethylammonium chloride, lauroylaminopropyldimethylethylammonium sulfate, lauroylaminopropyldimethylhydroxyethylammonium perchlorate, alkylbenzene dimethylammonium chloride and alkyltrimethylammonium chloride, and vinylpyrrolidone.

Examples of the nonionic surfactant may include alkylether such as: polyoxyethyleneoctylether, polyoxyethylenelauryl ether, polyoxyethylenestearylether, and polyoxyethylene oleylether; alkylphenylether such as polyoxyethyleneoctylphenylether, and polyoxyethylenenonylphenylether; alkyl ester such as polyoxyethylene laurate, polyoxyethylenestearate, and polyoxyethylene olate; alkylamine such as polyoxyethylenelauryl aminoether, polyoxyethylenestearylaminoether, polyoxyethylene oleylaminoether, polyoxyethylene soybean aminoether, and polyoxyethylene suet aminoether; alkylamide such as polyoxyethylenelauric acidamide, polyoxyethylenestearic acid amide, and polyoxyethyleneoleic acid amide; vegetable oil ether such as polyoxyethylene castor oil ether, and polyoxyethylene rapeseed oil ether; alkaneolamide such as lauric acid diethanolamide, stearic acid diethanolamide, and oleic acid diethanolamide; and sorbitan ester ether such as polyoxyethylene sorbitan monolaurate, polyoxyethylene sorbitan monopalmitate, polyoxyethylene sorbitan monostearate, and polyoxyethylene sorbitan monoolate.

The dispersant may be at least one selected from the group consisting of an epoxy resin, polyvinyl alcohol, polyvinyl butyral, polyvinyl pyrrolidone, glucose, sodium dodecylsulfate, sodium citrate, oleic acid and linoleic acid.

The toner may include a charge control agent. The charge control agent may be selected from the group consisting of a salicylic acid compound containing metals such as zinc and aluminum, boron complexes of bis diphenyl glycolic acid, and silicate. For example, the charge control agent may be dialkyl salicylic acid zinc, boro bis(1,1-diphenyl-1-oxo-acetyl potassium salt), or the like. The amount of the charge control agent may be, for example, from about 0.1 to about 10, or from about 1 to about 7 parts by weight based on 100 parts by weight of the binder resin. When the amount of the charge control agent is in the range of about 0.1 to about 10 parts by weight based on 100 parts by weight of the binder resin, a developing issue due to a reduction in charge properties or overcharge of a prepared toner may be prevented and/or reduced, and the pulverization/distribution performance can be improved and/or increased in a pulverizer/distributer for pulverization after extruding the toner during the preparation of the toner so as to increase a yield in mass production.

The electrophotographic toner may be coated by an external additive layer including an external additive such as silica, metal oxide or a polymer bead.

The amount of silica as the external additive may be from about 0.1 to about 10, or from about 0.5 to about 5.0 parts by weight based on 100 parts by weight of the binder resin. When the amount of silica is in the range of about 0.1 to about 10 parts by weight based on 100 parts by weight of the binder resin, the fluidity of a prepared toner is improved, and image contamination and developing errors may be prevented.

Silica is typically used as a dehumidifying agent, but the function of silica may vary according to a particle size of silica. Silica having a primary particle size of about 30 to about 200 nm is referred to as large particle silica, and silica having a primary particle size of about 5 to about 20 nm is referred to as small particle silica.

The terminology “primary particle” used throughout this specification refers to a unit particle of a compound that is not polymerized and bonded. The small particle silica can be added so as to improve and/or increase the fluidity of a toner particle, and the large particle silica can be added so as to impart charge properties to toner particles. The external additive may include small particle silica and large particle silica in a predetermined ratio. That is, the amount of small particle silica having a primary particle size of about 5 to about 20 nm can be in the range of about 0.05 to about 5 parts weight based on 100 parts by weight of the binder resin, and the amount of large particle silica having a primary particle size of about 30 to about 200 nm can be in the range of about 0.05 to about 5 parts by weight based on 100 parts by weight of the binder resin.

The primary particle sizes of the small particle silica and the large particle silica included in the external additive layer may be determined in consideration of the compatibility with toner particles and the toner particle size.

When the total amount of silica is in the range of about 0.1 to about 10 parts by weight based on 100 parts by weight of the binder resin 100, the fluidity of the toner may be improved due to the silica, and it may be easy to control the charge properties imparted to the toner particles.

Metal oxide of the external additive can include titanium dioxide. The amount of the titanium dioxide can be, for example, from about 0.1 to about 5, or from about 0.5 to about 2.0 parts by weight based on the 100 parts by weight of the binder resin 100. The titanium dioxide can have one or more acid values, in addition to TiO₂, but TiO₂ is a general form. Titanium dioxide can be dissolved in alkali to form alkali titanate. Titanium dioxide can be used as white pigment (titan white) having increased hiding power, and titanium dioxide can be used in ceramics, adhesives, medicines, and cosmetics. The titanium dioxide of the external additive can control overcharging that occurs when only silica is contained. The titanium dioxide may be surface-processed with alumina and organopolysiloxane, and may have a primary particle size of about 10 to about 200 nm. A diameter of the titanium dioxide may be determined in consideration of the compatibility with toner particles and the toner particle size, like in the case of silica. The surface-processed titanium dioxide may have a BET (Brunauer, Emmett, and Teller) surface area of about 20 m²/g to about 100 m²/g.

The external additive layer of the electrophotographic toner may include a polymer bead as an external additive, in addition to the metal oxide and silica. The polymer bead may be a styrene-based resin, methyl methacrylate, a styrene-methyl methacrylate copolymer, an acryl-based resin, or an acryl-styrene copolymer, and may be used alone or in a combination. The polymer bead can be prepared using a polymerization process such as suspension polymerization, and may have a particle size of a submicron to several tens of microns. The polymer bead may be included in the external additive layer. In this case, the amount of the polymer bead may be, for example, from about 0.1 to about 10, or from about 0.2 to about 2 parts by weight based on 100 parts by weight of the binder resin. When the amount of the polymer bead is in the range of about 0.1 to about 10 parts by weight based on 100 parts by weight of the binder resin, the charging properties of toner may be improved, and image contamination may be prevented.

The electrophotographic toner may include internal additives or external additives in order to improve and/or increase its performance. For example, a charge control agent, a ultra violet (UV) stabilizer, a mildewcide, a bactericide, a fungicide, an antistatic agent, a gloss modifier, an antioxidant, or an anticaking agent such as silane or silicon-modified silica particle may be used alone or in a combination of at least two thereof, and may be included as the internal additive or the external additive in the toner composition. The amount of the internal additive or the external additive may be from about 0.1 to about 10 parts by weight based on 100 parts by weight of the binder resin.

A volume average diameter of the electrophotographic toner may be, for example, about 4.0 to about 12.0 μm, or about 6.0 to about 9.0 μm. When the volume average diameter is in the range of about 4.0 to about 12.0 μm, the cleaning and reduction in yield in mass production of an organic photoconductor (OPC) may be overcome and/or improved, toner may be uniformly charged, the fixability of toner may be improved, and a toner layer may be regulated by using a doctor blade.

The electrophotographic toner may be prepared using a known preparation method such as a pulverization method, a polymerization method or a spray method. For example, in the pulverization method, toner is obtained by melting and mixing a binder resin, a colorant, a releasing agent, and a spherical metal nanoparticle. After pulverizing, this mixture can be sorted until particles of a desired size are obtained.

In an emulsion aggregation method of the polymerization method, a binder region dispersion solution can be prepared by emulsion aggregation, a colorant dispersion solution can be prepared by dispersing a colorant in a solvent, and the binder region dispersion solution and the colorant dispersion solution can be mixed with each other to form agglomerates having a diameter corresponding to the toner. The agglomerates can be heated and fused-coalesced to prepare the toner. In this case, the spherical metal nanoparticle may be added by mixing the spherical metal nanoparticle with the binder resin dispersion solution or the colorant dispersion solution.

According to exemplary embodiments of the present general inventive concept, a method of preparing an electrophotographic toner can include preparing a mixture solution including a polymerizable monomer, a colorant, a releasing agent, and a spherical metal nanoparticle, putting the mixture solution into an aqueous dispersion solution prepared by dissolving a dispersant in water so that suspension polymerization proceeds, and removing the dispersant and drying the resultant to obtain toner particles.

The method of preparing the electrophotographic toner will be described in detail.

A polymerizable monomer, a colorant, a releasing agent, and a spherical metal nanoparticle can be mixed to prepare a mixture solution as a polymerization material. When the mixture solution is prepared, the polymerizable monomer and the colorant are agitated with a bead mill, a bead can be removed to prepare a monomer mixture, and a temperature increases. In addition to the releasing agent and the spherical metal nanoparticle, at least one of a chain transfer agent and a charge control agent may optionally be added to the monomer mixture solution, and may be sufficiently dissolved while being agitated. An initiator can be added to the resultant, and the resultant can be agitated to prepare the mixture solution.

The polymerizable monomer used herein may include at least one selected from the group consisting of: styrene-based monomers such as styrene, vinyltoluene, or α-methylstyrene; acrylic acids, methacrylic acids; derivatives of (meth)acrylic acid such as methyl acrylate, ethyl acrylate, propyl acrylate, butyl acrylate, 2-ethylhexyl acrylate, dimethylaminoethyl acrylate, methyl methacrylate, ethyl methacrylate, propyl methacrylate, butyl methacrylate, 2-ethylhexyl methacrylate, dimethylaminoethyl methacrylate, acrylonirile, methacrylonirile, acrylamide, or methacrylamide; ethylenically unsaturated monoolefines such as ethylene, propylene, butylene or butadiene; halogenated vinyls such as vinyl chloride, vinylidene chloride, or vinyl fluoride; vinyl esters such as vinyl acetate or vinyl propionate; vinyl ethers such as vinylmethylether or vinylethylether; vinyl ketones such as vinylmethylketone or methylisoprophenylketone; a nitrogen-containing vinyl compound such as 2-vinylpyridine, 4-vinylpyridine, or N-vinylpyrrolidone; and a polyether-based monomer, a polyamide-based monomer and a polyurethane-based monomer that have a polymerizable functional group in a molecular chain. These compounds may be used alone or in a combination of at least two compounds.

In exemplary embodiments of the present general inventive concept, the black and white toner may include carbon black or aniline black as the colorant. The color toner may include carbon black as a black colorant, and may include yellow, magenta and cyan colorants as color pigments.

The colorant may be of any amount so as to color the toner. For example, the amount of the colorant may be from about 0.1 to about 20, or from about 2 to about 10 parts by weight based on 100 parts by weight of the polymerizable monomer. When the amount of the colorant is in the range of about 0.1 to about 20 parts by weight based on 100 parts by weight of the polymerizable monomer, the coloring effect of the colorant may be obtained, dispersion between the polymerizable monomer and colorant may be simplified, the manufacturing costs of the toner may not be increased, and a friction electric charge may be obtained.

A releasing agent may be selected according to one or more characteristics of a final toner. Examples of the releasing agent include, but are not limited to, polyethylene-based wax, polypropylene-based wax, silicon wax, paraffin-based wax, ester-based wax, carnauba wax, metallocene wax, and the like.

The amount of the releasing agent may be, for example, in the range of about 1 to about 20, or from 1 to about 10 parts by weight based on 100 parts by weight of the polymerizable monomer. When the amount of the releasing agent is in the range of about 1 to about 20 parts by weight based on 100 parts by weight of the polymerizable monomer, the releasing properties and durability of a prepared toner may be improved an/or increased.

The spherical metal nanoparticle may be at least one selected from the group consisting of: silver (Ag), gold (Au), platinum (Pt), palladium (Pd), iron (Fe), nickel (Ni), aluminum (Al), antimony (Sb), tungsten (W), terbium (Tb), dysprosium (Dy), gadolinium (Gd), europium (Eu), neodymium (Nd), praseodymium (Pr), strontium (Sr), magnesium (Mg), copper (Cu), zinc (Zn), cobalt (Co), manganese (Mn), chromium (Cr), vanadium (V), molybdenum (Mo), zirconium (Zr), and barium (Ba).

The amount of the spherical metal nanoparticle is, for example, from about 0.005 to about 10, or from about 0.01 to about 5 parts by weight based on 100 parts by weight of the polymerizable monomer. When the amount of the spherical metal nanoparticle is in the range of about 0.005 to about 10 parts by weight based on 100 parts by weight of the polymerizable monomer, the spherical metal nanoparticle may be equally dispersed rather than being aggregated in the toner. Thus, when heat is applied from an external heat source in order to fix the toner, since heat is dispersed throughout the entire toner due to the high thermal conductivity of the spherical metal nanoparticle, the same fixability may be obtained at a lower fusing temperature than a fusing temperature for fusing a typical toner.

The spherical metal nanoparticle may be added alone in a mixture solution, or, alternatively, may be added as a dispersion solution including a surfactant or a dispersant, to stably maintain a dispersion state when the toner is prepared.

The surfactant or dispersant may be a material that is dissolvable in an organic solution and/or aqueous solution having polarity of 1.8 or more in consideration of a solvent or a binder region when a toner is prepared.

Examples of the surfactant may include: an anionic surfactant such as salts of sulfate ester-based anionic surfactant, salts of sulfonate-based anionic surfactant, salts of phosphate ester-based anionic surfactant, and a soap-based anionic surfactant; a cationic surfactant such as an amine-salt cationic surfactant, and a quaternary ammonium salt cationic surfactant; and a nonionic surfactant such as a polyethylene glycol-based nonionic surfactant, an alkylphenolethyleneoxide adduct-based nonionic surfactant, and a polyvalent alcohol-based nonionic surfactant. The dispersant may be at least one selected from the group consisting of: an epoxy resin, polyvinyl alcohol, polyvinyl butyral, polyvinyl pyrrolidone, glucose, sodium dodecylsulfate, sodium citrate, oleic acid and linoleic acid.

For example, when a gold (Au) nanoparticle is selected as the spherical metal nanoparticle, the Au nanoparticle can be surrounded by a cetyl trimethyl ammonium bromide (CTAB), and the Au nanoparticle may be stably maintained, even when in an aqueous solution. However, since CTAB includes bromine (Br) that may adversely affect the human body, CTAB may be replaced with an environmentally compatible surfactant that may not adversely affect the human body. For example, methoxy-polyethylene glycol-thiol (mPEG-SH) dissolvable in toluene with a polarity of 2.3 can be selected as the Au nanoparticle, and thus the Au nanoparticle may be dissolvable in an aqueous solution and an organic solvent, and increased stability and optical absorption may be simultaneously realized. A material formed by stabilizing the Au nanoparticle with methoxy-polyethylene glycol-thiol (mPEG-SH) is available from a product ‘NSON 30-NS850’ of Nanopartz™ company. Polyvinyl-pyrrolidone (PVP) dissolvable in iso-propanol having a polarity of 4.3 may be selected as the surfactant of the Au nanoparticle.

A hydroxide of the surfactant or dispersant added to increase the dispersibility of the spherical metal nanoparticle may hydrolyze the binder resin formed during the suspension polymerization of the aqueous dispersion solution so as to reduce a molecular weight of the binder resin. The same and/or similar image quality may be obtained at a lower temperature than by using a typical toner, and thus a low temperature fixable toner may be obtained.

The dispersant can be dissolved in water to prepare an aqueous dispersion solution, the mixture solution is put in the aqueous dispersion solution so that suspension polymerization proceeds. A temperature of the aqueous dispersion solution can be increased to a polymerization reaction temperature, for example, a temperature of about 50° C. to about 90° C., and the mixture solution can be added to the aqueous dispersion solution. A suspension polymerization reaction can occur when the resultant is agitated by a homogenizer. In the suspension polymerization reaction, the resultant may be agitated by the homogenizer at a predetermined high speed (e.g., a speed of about 5,000 to about 20,000 rpm), and may be agitated by a general agitator at a predetermined low speed (e.g., a speed of 2,000 rpm or less).

Examples of the dispersant include, but are not limited to, an inorganic dispersant such as phosphoric acid calcium salt, a magnesium salt, hydrophilic silica, water-repellent silica, and colloidal silica; a nonionic polymer dispersant such as polyoxyethylene alkylether, polyoxyalkylene alkylphenolether, sorbitan fatty acid ester, polyoxyalkylene fatty acid ester, glycerin fatty acid ester, polyvinyl alcohol, alkyl cellulose, and polyvinyl pyrrolidone; and an ionic polymer dispersant such as polyacryl amide, polyvinyl amine, polyvinyl amine N-oxide, polyvinyl ammonium salt, polydialkyldiallyl ammonium salt, polyacrylic acid, polystyrene sulfonic acid, salts of polyacrylate, salts of poly sulfonate, and salts of polyaminoalkyl acrylate. These dispersants may be used alone or in a combination.

The amount of the dispersant may be, for example, from about 0.01 to about 10, or from about 0.1 to about 5 parts by weight based on 100 parts by weight of water. When the amount of the dispersant is in the range of about 0.01 to about 10 parts by weight based on 100 parts by weight of water, a reaction stability may be improved and/or increased during the suspension polymeration, the formation of byproducts such as emulsion particles may be prevented and/or minimized, and a toner particle having a predetermined appropriate size may be formed.

In exemplary embodiments of the present general inventive concept, a cationic surfactant may be added along with the dispersant. An example of the anionic surfactant may be at least one selected from the group consisting of: fatty acid salt, alkyl sulfuric acid ester salt, alkylaryl sulfuric acid ester salt, dialkyl sulfosuccinic acid salt, and alkyl phosphoric acid salt. An amount of the cationic surfactant may be, for example, from about 0.001 to about 20, from about 0.01 to about 10, or from about 0.1 to about 5 parts by weight based on 100 parts by weight of water. When the amount of the cationic surfactant is in the range of about 0.001 to about 20 parts by weight based on 100 parts by weight of water, reaction stability during the suspension polymerization may be improved and/or increased.

Examples of the polymerization initiator include, but are not limited to: persulfates such as potassium persulfate or ammonium persulfate; azo compounds such as 4,4-azobis(4-cyano valeric acid), dimethyl-2,2′-azobis(2-methylpropionate), 2,2-azobis(2-amidinopropane)dihydrochloride, 2,2-azobis-2-methyl-N-1,1-bis(hydroxymethyl)-2-hydroxyethylpropioamide, 2,2′-azobis(2,4-dimethylvaleronitrile), 2,2′-azobisisobutyronitrile, or 1,1′-azobis(1-cyclohexancarbonitrile); and peroxides such as methylethylperoxide, di-t-butylperoxide, acetylperoxide, dikumylperoxide, lauroylperoxide, benzoylperoxide, t-butylperoxy-2-ethyl hexanoate, di-isopropylperoxydicarbonate, or di-t-butylperoxyisophthalate, and the like. An oxidation-reduction initiator may be formed by combining the polymerization initiator and a reducer. The amount of the polymerization initiator is from about 0.01 to about 5, or from about 0.1 to about 3 parts by weight based on 100 parts by weight of the polymerizable monomer. When the amount of the polymerization initiator is in the range of about 0.01 to about 5 parts by weight based on 100 parts by weight of polymerizable monomer, the occurrence of a non-reacted material may be prevented, and a reaction speed may be controlled, to improve and/or increase reaction stability.

A chain transfer agent can refer to a material that changes the type of a chain carrier during a chain reaction, or a material that significantly reduces the activity of a new chain compared to that of existing chains. When the chain transfer agent is used, the degree of polymerization of polymerizable monomers may be reduced, and reaction for a novel chain may be initiated. The molecular weight distributions of toner may be controlled when the change transfer agent is used.

The amount of the chain transfer agent may be, for example, in the range of about 0.1 to about 5 parts by weight, about 0.2 to about 3 parts by weight, or about 0.5 to about 2.0 parts by weight, based on 100 parts by weight of the polymerizable monomer. If the amount of the chain transfer agent is within the above range, the toner may have an appropriate molecular weight to carry out the exemplary embodiments of the present general inventive concept disclosed herein, and may have improved and/or increased fixability.

Examples of the chain transfer agent include, but are not limited to: sulfur-containing compounds such as dodecanethiol, thioglycolic acid, thioacetic acid, and mercaptoethanol; phosphorous acid compounds such as a phosphorous acid and sodium phosphorous acid; hypophosphorous acid compounds such as a hypophosphorous acid and a sodium hypophosphorous acid; and alcohols such as methyl alcohol, ethyl alcohol, isopropyl alcohol, n-butyl alcohol, and the like.

A charge control agent may be added during the polymerization. As described above, the charge control agent may be selected from the group consisting of: a salicylic acid compound containing metals such as zinc and aluminum, boron complexes of bis diphenyl glycolic acid, and silicate. For example, the charge control agent may be dialkyl salicylic acid zinc, boro bis(1,1-diphenyl-1-oxo-acetyl potassium salt), or the like.

The amount of the charge control agent may be, for example, from about 0.1 to about 10, or from about 1 to about 7 parts by weight based on 100 part by weight of the polymerizable monomer. When the amount of the charge control agent is in the range of about 0.1 to about 10 parts by weight based on 100 part by weight of the polymerizable monomer, a developing issue due to a reduction in charge properties or overcharging of a prepared toner may be prevented and/or reduced, and the pulverization/distribution performance can be improved and/or increased in a pulverizer/distributer for pulverization after extruding toner during the preparation of the toner so as to increase a yield in mass production.

The electrophotographic toner may include one or more additives such as a charge control agent, a UV stabilizer, a mildewcide, a bactericide, a fungicide, an antistatic agent, a gloss modifier, an antioxidant, an anti-coagulation such as silane or a silicon-modified silica particle, which may be used alone or in a combination of at least two thereof. The amount of the additive may be in the range of about 0.1 to about 10 parts by weight based on 100 parts by weight of the polymerizable monomer.

An alkaline aqueous solution or an acid alkaline aqueous solution may be added after polymerization according to a kind of the dispersant to remove the dispersant, and can be washed and filtered with water to separate the dispersant. For example, when colloidal silica is used as the aqueous dispersant, NaOH having a concentration of about 0.05 to about 0.2 N may be added to remove the colloidal silica. The above-described process can be repeated until the dispersant is separated from toner particles. When the dispersant is separated from the toner particles, the toner particles can be dried in a vacuum oven to prepare the toner.

An external additive can be added to the dried toner particles, and the amount of charges is controlled, so as to form a final dry toner. The external additive may be silica, metal oxide, or polymer bead. The external additive may prevent caking in which toner particles can be aggregated to each other due to an aggregation force therebetween, a roller contamination due to an excessive amount of the external additive that is greater than a predetermined threshold may be prevented and/or minimized, and a predetermined stable quantity of electric charge may be obtained.

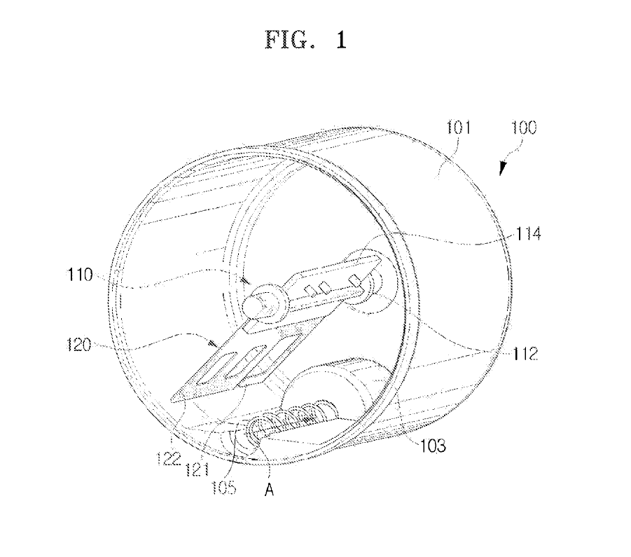

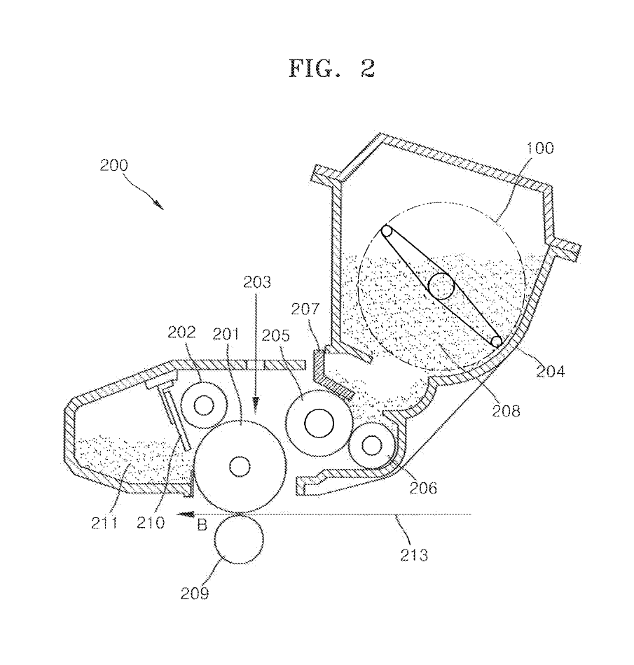

FIG. 1 illustrates a view of a toner supplying device 100 according to exemplary embodiments of the present general inventive concept. The toner supplying device 100 may be disposed in an image forming apparatus to form an image onto a printing medium, such as illustrated in FIG. 2 and described below. Referring to FIG. 1, the toner supplying device 100 may include a toner tank 101, a supplying part 103, a toner-conveying member 105 and a toner-agitating member 110. In exemplary embodiments of the present general inventive concept, the toner supplying device 100 may be a toner cartridge.

The supplying part 103 may be disposed on an inner bottom surface of the toner tank 101, and may externally discharge toner contained in the toner tank 101. The supplying part 103 may include a toner outlet (not illustrated) in an outer side thereof, through which the toner may be discharged. The toner-conveying member 105 may be disposed at a side of the supplying part 103 on the inner bottom surface of the toner tank 101. The toner-conveying member 105 may have, for example, a coil spring shape, or any other suitable shape so as to convey toner from the toner tank 101 to the toner outlet via the supply part 103 according to the exemplary embodiments of the present general inventive concept as disclosed herein. An end of the toner-conveying member 105 may extend inside the supplying part 103 so that toner in the toner tank 101 is conveyed into the supplying part 103, i.e., a direction A in which the toner is supplied, as the toner-conveying member 105 rotates. Toner conveyed by the toner-conveying member 105 may be externally discharged through the toner outlet of the supplying part 103. The toner-agitating member 110 can include a rotation shaft 112 and a toner agitating film 120. The toner-agitating member can be rotatably disposed inside the toner tank 101 and can force toner in the toner tank 101 to move in a radial direction when a force is applied to the rotation shaft 112 such that the rotation shaft 112 rotates. The rotation shaft 112 may have a support plate 114 that may be affixed to the rotation shaft 112 to fix a toner-agitating film 120 to the rotation shaft 112. That is, the toner agitating film 120 may be affixed to the support plate 114, where the support plate 114 is affixed to the rotation shaft 112. The toner-agitating film 120 may include a first agitating part 121 and a second agitating part 122. For example, the toner-agitating film may be formed by cutting an end of the toner-agitating film 120 toward the rotation shaft 112 by a predetermined length. That is, one end of the first agitating member 121 may be spaced from an adjacent end of the second agitating member 122, so that the one end and the adjacent end may independently move.

FIG. 2 is a cross-sectional view illustrating an image forming apparatus 200 having a non-contact type one component developing method, according to exemplary embodiments of the present general inventive concept. The image forming apparatus 200 is an example of a developing apparatus 203 accommodating a toner 208, according to exemplary embodiments of the present general inventive concept. Referring to FIG. 2, the image forming apparatus includes a photosensitive drum 201, a charge roller 202, a developing roller 205, a toner-supplying roller 206, a toner layer regulator 207, and a transfer roller 209.

The photosensitive drum 201 is an example of an image carrier on which an electrostatic latent image is formed, and includes a photosensitive layer formed of a photosensitive material on an external surface of a metallic drum, where a photosensitive belt having a belt shape may be used as the image carrier. The charge roller 202 is an example of a charger to charge a surface of the photosensitive drum 201 while rotating and being in contact with the photosensitive drum 201. A charge bias can be applied to the charge roller 202. A corona charger (not illustrated) may be used instead of the charge roller 202.

The surface of the photosensitive drum 201 can be charged with a predetermined voltage by the charge roller 202. An electrostatic latent image can be formed by light emitted from a light-scanning unit (not illustrated) on the charged surface of the photosensitive drum 201. The toner 208 accommodated in a housing 204 can be supplied to a surface of the developing roller 205 by the toner-supplying roller 206. The toner 208 supplied to the surface of the developing roller 205 is thinned to a uniform thickness by the toner layer regulator 207, and simultaneously is rubbed by the developing roller 205 and the toner layer regulator 207 to be charged in a predetermined polarity. The toner 208 can be moved towards the surface of the photosensitive drum 201 by the developing roller 205 that rotates while being spaced apart from the photosensitive drum 201 by a predetermined distance. The toner 208 can be moved by a voltage difference between electrostatic latent images formed on surfaces of the developing roller 205 and the photosensitive drum 201. The toner 208 that is moved towards the surface of the photosensitive drum 201 can be attached to the electrostatic latent image, and thus the electrostatic latent image is formed as a desired image. The image formed on the surface of the photosensitive drum 201 can be transferred on a recording medium 213 by a transfer medium (not illustrated). The transfer roller 209 can feed the recording medium 213 in a direction B so that the image formed on the surface of the photosensitive drum 201 can be transferred. A portion of the toner 208, which accumulates on the surface of the photosensitive drum 201 after the image is transferred, can be removed by a cleaning blade 210, and can be stored in a waste storage unit 211.

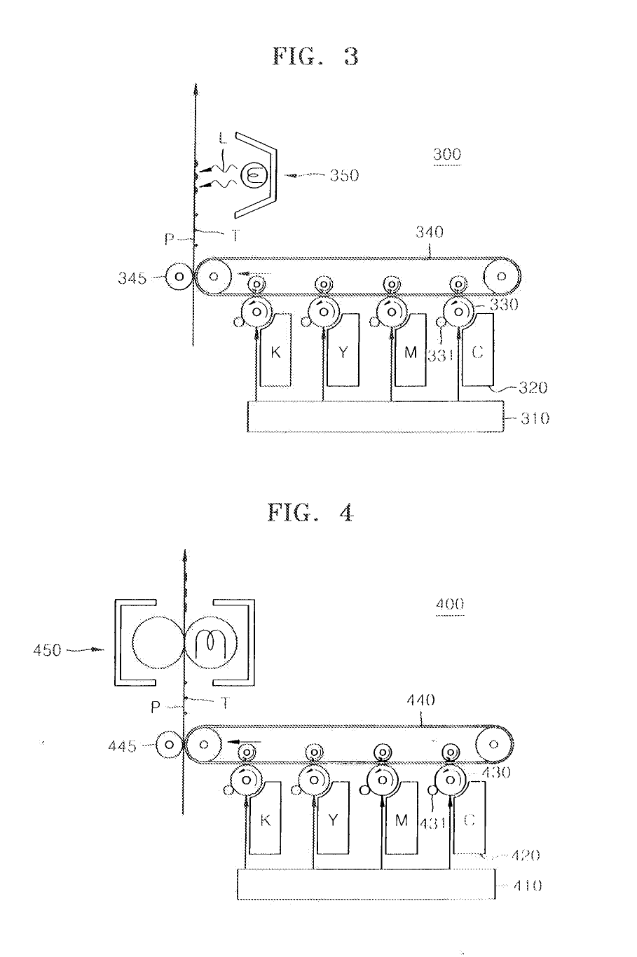

FIG. 3 is a schematic diagram illustrating an image forming apparatus 300 using a toner to form an image onto recording medium P according to exemplary embodiments of the present general inventive concept. Referring to FIG. 3, the image forming apparatus 300 may include a light-scanning unit 310, at least four toner-supplying units 320 (e.g., for colors cyan (“C”), magenta (“M”), yellow (“Y”), and black (“K”) illustrated in FIG. 3), at least four photosensitive drums 330, at least four charge rollers 331, an intermediate transfer belt 340, a transfer roller 345, and a fusing unit 350.

In order to print a color image, the light-scanning unit 310, the four toner-supplying units 320 and the photosensitive drums 330 may be provided for each color, respectively. For example, as illustrated in FIG. 3, toner-supplying units 320 may be provided for the colors cyan (“C”), magenta (“M”), yellow (“Y”), and black (“K”). The light-scanning unit 310 can be a device to scan light that is modified according to image information onto the four photosensitive drums 330. The four toner-supplying units 320 may include the housing 204, the toner-supplying roller 206 and the developing roller 205, which are illustrated in FIG. 2. The light-scanning unit 310 scans four light beams onto the four photosensitive drums 330, respectively. Electrostatic latent images corresponding to image information of black (K), magenta (M), yellow (Y) and cyan (C) colors are formed on the four photosensitive drums 330. The four toner-supplying units 320 supply toners of K, M, Y and C colors respectively to the four photosensitive drums 330 to form toner images of K, M, Y and C colors.

Toner images of K, M, Y and C colors formed on the four photosensitive drums 330 are transferred onto the intermediate transfer belt 340. The toner images are then transferred on a recording medium (P) moved between the transfer roller 345 and the intermediate transfer belt 340 by a transfer bias voltage applied to the transfer roller 345.

The fusing unit 350 can include a light source irradiating a light beam L onto the recording medium P onto which the toner image is transferred. An image can be formed by melting and fusing a toner T, which forms the toner image, with the light beam L emitted from the transfer roller 345.

The light source of the fusing unit 350 may be a xenon lamp that emits a predetermined large amount of light for a predetermined short period of time. The xenon lamp may emit light having a wideband wavelength range, in particular, light in the infrared ray range.

The electrophotographic toner according to exemplary embodiments of the present general inventive concept may be used in other image forming apparatuses, as well as an in image forming apparatus using a flash fusing method. For example, FIG. 4 is a schematic diagram illustrating an image forming apparatus 400 using a toner, according to exemplary embodiments of the present general inventive concept. Referring to FIG. 4, the image forming apparatus 400 may include a light-scanning unit 410, four toner-supplying units 420 (e.g., for colors cyan (“C”), magenta (“M”), yellow (“Y”), and black (“K”) illustrated in FIG. 4), four photosensitive drums 430, four charge rollers 431, an intermediate transfer belt 440, a transfer roller 445, and a fusing unit 450. The fusing unit 450 can include a heating roller and a pressurizing roller, which can be engaged with each other to form a fusing nip. All the elements of the image forming apparatus 400, except the fusing unit 450, are substantially the same as those of the image forming apparatus 300 illustrated in FIG. 3 and described above.

The fusing nip of the fusing unit 450 can be normally maintained at a fusing temperature of 170° C. In a toner according to exemplary embodiments of the present general inventive concept, a general binder resin such as a polyester resin can be included in the toner. A temperature of a material of the general binder resin can be lower than 170° C., and the general binder resin can be heated and pressurized when being passed through a recording medium P to be melted and fused.

According to exemplary embodiments of the present general inventive concept, an image forming method using a toner can include attaching the toner to a surface of a photosensitive substance (e.g., photosensitive drums 330 illustrated in FIG. 3 and/or photosensitive drums 430 illustrated in FIG. 4) on which an electrostatic latent image can be formed and transferring a visual image onto a transfer medium. For example, the image forming method may be performed using the image forming apparatus 300 or 400 of FIG. 3 or 4. Typical electrophotographic imaging processes include one or more imaging processes on a receptor, including charging, exposure-to-light, developing, transferring, fixing, cleaning, and erasing processes.

In the charging process, a surface of a photoreceptor can be charged with negative or positive charges, whichever is desired, by a corona or a charge roller. In the exposure-to-light process, the charged surface of the image carrier can be selectively discharged using a laser scanner or an array of diodes in an image-wise manner to form a latent image corresponding to a final visual image to be formed on a final-image receptor, such as, for example, a sheet of paper and/or any other suitable recording medium unto which an image may be formed according to the exemplary embodiments of the present general inventive concept as disclosed herein. Electromagnetic radiation that may be referred to as “light radiation” can include, but is not limited to, infrared radiation, visible light radiation, and ultraviolet radiation.

In the developing process, polar toner particles generally contact the latent image of the image bearing unit, and conventionally, an electrically-biased developer having identical potential polarity to the toner polarity is used. The toner particles can move to the photoreceptor and can be selectively attached to the latent image by an electrostatic force to form a toner image on the photoreceptor.

In the transferring process, the toner image can be transferred to the final-image receptor from the photoreceptor. An intermediate transfer element can be used at least in part to transfer the toner image from the photoreceptor, for example, to the final-image receptor.

In the fixing process, the toner image on the final-image receptor can be heated to soften or melt toner particles, to fix the toner image to the final-image receptor. An alternative fixing method may include fixing the toner image to the final-image receptor with a predetermined high pressure with or without the application of heat.

In the cleaning process, residual toner remaining on the photoreceptor can be removed.

In the erasing process, the photoreceptor can be exposed to light having a predetermined wavelength to substantially uniformly reduce the amount of charges on the photoreceptor, to remove the residue of the original latent image from the photoreceptor so that the photoreceptor is ready for a next imaging cycle.

Hereinafter, exemplary embodiments of the present general inventive concept will be described in detail with reference to the following examples. However, these examples are not intended to limit the purpose and scope of the one or more embodiments of the present general inventive concept.

### Example 1

234 g of styrene, 96 g of n-butyl acrylate, and 14 g of methacrylic acid were put in a 3 L beaker, were agitated by a bead mill for 2 hours at a speed of 2,000 rpm, and a bead was removed to prepare a monomer mixture. A temperature of the prepared monomer mixture increased by warming up with water at a temperature of 70° C., 60 g of Mogul-L as a black pigment, 28 g of 35% P-420 (Chukyo Yushi Co., Ltd) (amount of paraffin wax: 25-35%; amount of ester wax: 5-10%; and melting point; 85° C.), 5 g of 1-dodecanthiol as a chain transfer agent were added and agitated for 20 minutes so as to be sufficiently melted. 30 g of 0.1 wt % spherical gold (Au) nanoparticle dispersion solution (manufactured by NANOEM) and 7.5 g of azobisisobutyronitrile (AlBN) as a polymerization initiator were added and agitated for 3 minutes to prepare a mixture solution.

1500 g of distilled water and 37.5 g of colloidal silica were melted in a reactor, and a temperature increased to a reaction temperature of 70° C. to prepare an aqueous dispersion solution.

The prepared mixture solution was put into the aqueous dispersion solution, and was agitated by a homogenizer for 20 minutes at a speed of 10,000 rpm so that a reaction could occur. After 20 minutes, the resultant was agitated by a general agitator for 20 hours at a speed of 500 rpm so that a suspension polymerization reaction could occur to synthesize the toner particle. Washing and filtering the synthesized toner particles with water were repeated to remove the dispersant, and the resultant was dried in a vacuum.

1 parts by weight of large silica (available from Wacker Chemical company, under the product name H05TD), 1 parts by weight of small silica (available from Degussa company, under the product name RX300), 0.1 parts by weight of TiO₂, 0.1 parts by weight of maleamine-based polymer bead (available from Nippon Shokubai, under product name S) were mixed with the dried toner particles for 5 minutes at a speed of 3800 rpm to prepare an electrophotographic toner.

### Comparative Example 1

An electrophotographic toner was prepared in the same manner as in Example 1 except that the spherical Au nanoparticle was not added.

Evaluation of Toner

<Measurement of Softening Temperature>

The softening temperatures of the electrophotographic toners prepared in Example 1 and Comparative Example 1 were measured by using a capillary rheometer CFT-500D.

The softening temperature of the electrophotographic toner prepared in Example 1 was 127.3° C., and the softening temperature of the electrophotographic toner prepared in Comparative Example 1 was 132.5° C. The softening temperature of the electrophotographic toner including Au nanoparticles and prepared in Example 1 is about 5° C. lower than that of the electrophotographic toner including no Au nanoparticles and prepared in Comparative Example 1, and thus the electrophotographic toner prepared in Example 1 may be fixed at a predetermined low temperature compared to the electrophotographic toner prepared in Comparative Example 1.

<Measurement of Viscosity According to Temperature>

The viscosities of the electrophotographic toners prepared in Example 1 and Comparative Example 1 were measured by using an ARES measuring device available from the Rheometric Scientific company. The samples were put between two circular plates each having a diameter of 8 mm, and the viscosities of the samples were measured in a linear region at a heating rate of from 2 to about 3° C./min up to a final temperature of 40° C. to 180° C. Data was collected at a measuring interval of 30 seconds. After the measurement started, measurement accuracy was obtained within an error margin of 1° C.

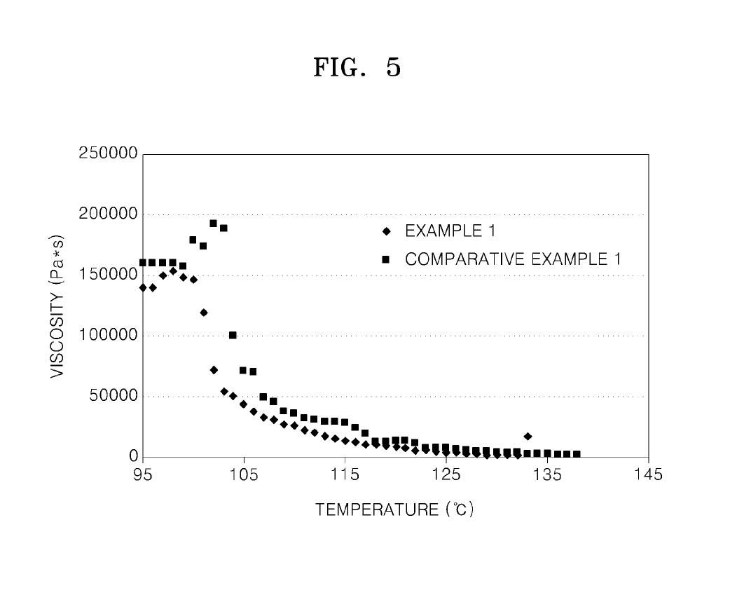

The measured results of the viscosities of the electrophotographic toners prepared in Example 1 and Comparative Example 1 are illustrated in FIG. 5. Referring to FIG. 5, the viscosity of the softening temperature of the electrophotographic toner including Au nanoparticles and prepared in Example 1 is lower than that of the electrophotographic toner including no Au nanoparticles and prepared in Comparative Example 1 at a temperature of about 95 to about 135° C., and thus may obtain a fixing effect even at a predetermined low temperature compared to a general fuser.

<Evaluation of Fixability>

In order to cold offset properties of the electrophotographic toners prepared in Example 1 and Comparative Example 1, five (5) sheets having a weight of 90 g were output and fixed with an image forming apparatus, the optical density (OD) of the fixed image was measured, a 3M® 810 tape was attached to the fixed image, a weight of 500 g was reciprocated thereon five times, and then the tape used was removed. After the 3M® 810 tape was removed, the OD was measured.

Fixability(%)=(OD after peeling off the tape)/(OD before peeling off the tape)×100

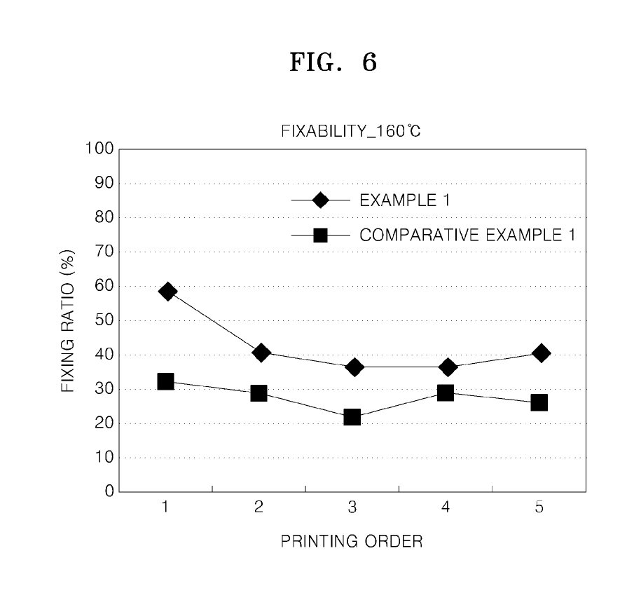

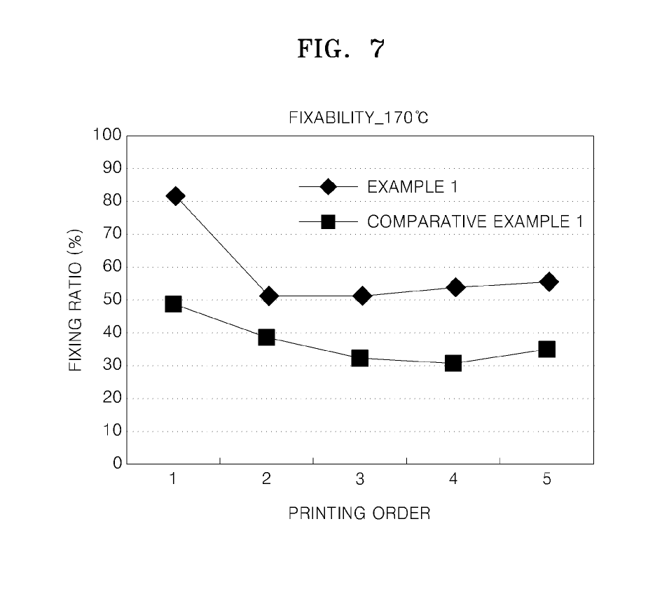

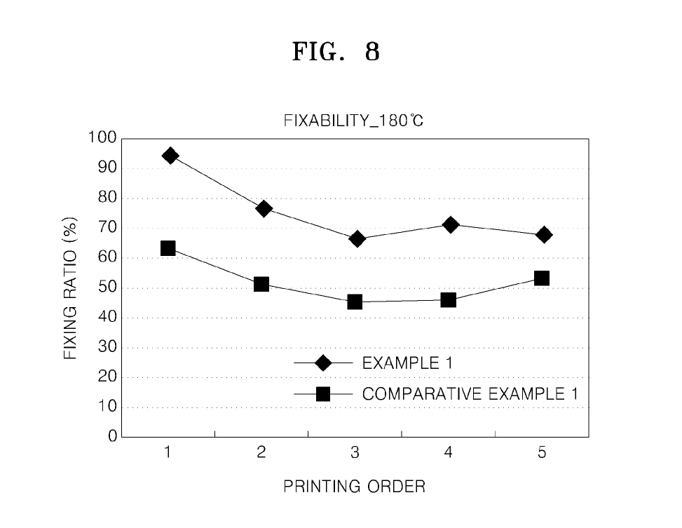

The fixabilities of the electrophotographic toners prepared in Example 1 and Comparative Example 1 were measured at fixing temperatures of 160° C., 170° C. and 180° C., and the measured results are illustrated in FIGS. 6 through 8, respectively. Referring to FIGS. 6 through 8, the electrophotographic toner prepared in Example 1 may be fixed at every temperature even though a printing number is increased, compared to the electrophotographic toner prepared in Comparative Example 1.

<Evaluation of Molecular Weight>

Molecular weights of the electrophotographic toners prepared in Example 1 and Comparative Example 1 were measured by using GPC (Gel Permeation Chromatography—available from Waters company). In this case, tetrahydrofuran was used as a solvent. A temperature of 35° C., a flow speed of 1.0 mL/min, an injection amount of 100 L, and a sample concentration of 3 mg/mL were used. The measurement results are illustrated in Table 1.

TABLE 1

| | | Comparative |
|---|---|---|
| | Example 1 | Example 1 |
| Number average molecular weight (Mn) | 1,035 | 3.311 |
| Weight average molecular weight (Mw) | 4,786 | 6,811 |
| Z average molecular weight (Mz) | 19,596 | 12,980 |
| Peak average molecular weight(Mp) | 2,325 | 5,165 |
| Polydispersity (PD) | 4.62 | 2.06 |

Referring to Table 1, the number average molecular weight of the electrophotographic toner including Au nanoparticles and prepared in Example 1 is smaller than that of the electrophotographic toner including no Au nanoparticles and prepared in Comparative Example 1. The polydispersity of the electrophotographic toner including Au nanoparticles and prepared in Example 1 is wider than that of the electrophotographic toner including no Au nanoparticles and prepared in Comparative Example 1. Thus, low temperature printing may be performed by reducing the viscosity of the electrophotographic toner prepared in Example 1 and reducing a fixing temperature during a printing operation.

While the present general inventive concept has been particularly illustrated and described with reference to exemplary embodiments thereof, it will be understood by those of ordinary skill in the art that various changes in form and details may be made therein without departing from the spirit and scope of the present general inventive concept as defined by the following claims.

What is claimed is:

1. An electrophotographic toner, comprising:
a binder resin, a colorant, a releasing agent, and a spherical metal nanoparticle having a volume average diameter of about 10 to about 100 nm.

2. The electrophotographic toner of claim 1, wherein the binder resin is at least one selected from the group consisting of a styrene resin, an acryl resin, a vinyl resin, a polyether polyol resin, a phenol resin, a silicon resin, a polyester resin, an epoxy resin, a polyamide resin, a polyurethane resin, and a polybutadiene resin.

3. The electrophotographic toner of claim 1, wherein a molecular weight of binder resin is in a range of about 700 to about 3,000.

4. The electrophotographic toner of claim 1, wherein the spherical metal nanoparticle is at least one selected from the group consisting of silver (Ag), gold (Au), platinum (Pt), palladium (Pd), iron (Fe), nickel (Ni), aluminum (Al), antimony (Sb), tungsten (W), terbium (Tb), dysprosium (Dy), gadolinium (Gd), europium (Eu), neodymium (Nd), praseodymium (Pr), strontium (Sr), magnesium (Mg), copper (Cu), zinc (Zn), cobalt (Co), manganese (Mn), chromium (Cr), vanadium (V), molybdenum (Mo), zirconium (Zr), and barium (Ba).

5. The electrophotographic toner of claim 1, wherein an amount of the colorant is in a range of about 0.1 to about 20 parts by weight, an amount of the releasing agent is in a range of about 1 to about 20 parts by weight, and an amount of the spherical metal nanoparticle is in a range of about 0.005 to about 10 parts by weight, based on 100 parts by weight of the binder resin.

6. The electrophotographic toner of claim 1, wherein a surface of the spherical metal nanoparticle is surrounded by a surfactant or a dispersant.

7. The electrophotographic toner of claim 6, wherein the surfactant is at least one selected from the group consisting of salts of sulfate ester-based surfactant, salts of sulfonate-based surfactant, salts of phosphate ester-based surfactant, soap-based surfactant, an amine-salt surfactant, a quaternary ammonium salt surfactant, a polyethylene glycol-based surfactant, an alkylphenolethyleneoxide adduct-based surfactant, a polyvalent alcohol-based surfactant, and a nitrogen-containing vinyl polymer-based surfactant, and
wherein the dispersant is at least one selected from the group consisting of an epoxy resin, polyvinyl alcohol, polyvinyl butyral, polyvinyl pyrrolidone, glucose, sodium dodecylsulfate, sodium citrate, oleic acid and linoleic acid.

8. A method of preparing an electrophotographic toner, the method comprising:
preparing a mixture solution comprising a polymerizable monomer, a colorant, a releasing agent, and a spherical metal nanoparticle;
combining the mixture solution with an aqueous dispersion solution prepared by dissolving a dispersant in water so that suspension polymerization proceeds; and
removing the dispersant and drying the resultant to form toner particles.

9. The method of claim 8, wherein an amount of the colorant is in a range of about 0.1 to about 20 parts by weight, an amount of the releasing agent is in a range of about 1 to about 20 parts by weight, and an amount of the spherical metal nanoparticle is in a range of about 0.005 to about 10 parts by weight, based on 100 parts by weight of the polymerizable monomer.

10. The method of claim 8, wherein the spherical metal nanoparticle is at least one selected from the group consisting of silver (Ag), gold (Au), platinum (Pt), palladium (Pd), iron (Fe), nickel (Ni), aluminum (Al), antimony (Sb), tungsten (W), terbium (Tb), dysprosium (Dy), gadolinium (Gd), europium (Eu), neodymium (Nd), praseodymium (Pr), strontium (Sr), magnesium (Mg), copper (Cu), zinc (Zn), cobalt (Co), manganese (Mn), chromium (Cr), vanadium (V), molybdenum (Mo), zirconium (Zr), and barium (Ba).

11. The method of claim 8, wherein the mixture solution comprises the spherical metal nanoparticle that is dispersed in a surfactant or a dispersant.

12. The method of claim 11, wherein the surfactant is at least one selected from the group consisting of salts of sulfate ester-based surfactant, salts of sulfonate-based surfactant, salts of phosphate ester-based surfactant, soap-based surfactant, an amine-salt surfactant, a quaternary ammonium salt surfactant, a polyethylene glycol-based surfactant, an alkylphenolethyleneoxide adduct-based surfactant, a polyvalent alcohol-based surfactant, and a nitrogen-containing vinyl polymer-based surfactant, and wherein the dispersant is at least one selected from the group consisting of an epoxy resin, polyvinyl alcohol, polyvinyl butyral, polyvinyl pyrrolidone, glucose, sodium dodecylsulfate, sodium citrate, oleic acid and linoleic acid.

13. A toner supplying device comprising:
a toner; and
a housing to contain the toner,
wherein the toner is an electrophotographic toner including a binder resin, a colorant, a releasing agent, and a spherical metal nanoparticle having a volume average diameter of about 10 to about 100 nm.

14. An image forming apparatus comprising:
an image carrier;
an image forming unit to form an electrostatic latent image on a surface of the image carrier;
a unit receiving toner;
a toner-supplying unit to supply the toner to the surface of the image carrier to develop the electrostatic latent image into a toner image on the surface of the image carrier; and
a toner transferring unit to transfer the toner image onto the surface of the image carrier, wherein the toner is an electrophotographic toner including a binder resin, a colorant, a releasing agent, and a spherical metal nanoparticle having a volume average diameter of about 10 to about 100 nm.

15. A method of preparing an electrophotographic toner, the method comprising:
forming a binder region dispersion solution by emulsion aggregation and forming a colorant dispersion solution by dispersing a colorant in a solvent, where the binder region dispersion solution and the colorant dispersion solution are mixed with each other to form agglomerates having a predetermined diameter;
heating and fused-coalescing the formed agglomerates; and
mixing a spherical metal nanoparticle with the binder resin dispersion solution or the colorant dispersion solution.
